(19) United States
(12) Patent Application Publication
(10) Pub. No.: US 2017/0220158 A1
(43) Pub. Date: Aug. 3, 2017

(54) Touch Display Substrate, Touch Display Panel, Touch Display Screen and Electronic Device

(71) Applicant: BOE Technology Group Co., Ltd., Beijing (CN)

(72) Inventors: Min Peng, Beijing (CN); Yingtao Wang, Beijing (CN); Hong Wang, Beijing (CN)

(21) Appl. No.: 15/234,117

(22) Filed: Aug. 11, 2016

(30) Foreign Application Priority Data
Jan. 28, 2016 (CN) 201610059843.8

(51) Int. Cl. G06F 3/047; G06F 3/041

(52) U.S. Cl. CPC G06F 3/047; G06F 3/0412

(57) ABSTRACT

A touch display substrate, a touch display panel, a touch display screen and an electronic device are disclosed. The touch display substrate includes a base substrate and a wire grid polarizer (WGP) disposed on one side of the base substrate. The WGP includes a plurality of metal wires disposed in parallel; and the metal wires are configured for connecting with the touch integrated circuit (IC). The thickness of the touch display substrate is reduced, and the difficulty of coordinating the touch IC and the display IC is reduced.

This application claims priority to and the benefit of Chinese Patent Application No. 201610059843.8 filed on Jan. 28, 2016, which application is incorporated herein in its entirety.

### TECHNICAL FIELD

Embodiments of the present disclosure pertain to a touch display substrate, a touch display panel, a touch display screen and an electronic device.

### BACKGROUND

With the rapid popularization of mobile terminal devices, the touch display technology develops rapidly as well. In a conventional touch display technology, a display function and a touch function of a mobile terminal device are realized by disposing a touch panel on a liquid crystal display panel. With the growing requirement on light weight and thin profile for mobile terminal devices, the integration design of a touch panel and a liquid crystal panel becomes more popular and draws more attention. The integration technology of a touch panel and a liquid crystal panel includes in-cell technology and on-cell technology. In-cell technology is such a technology that a touch panel is embedded into a liquid crystal panel.

### SUMMARY

The first aspect of the present disclosure provides a touch display substrate. The touch display substrate comprises a base substrate and a wire grid polarizer disposed on one side of the base substrate; the wire grid polarizer comprises a plurality of metal wires disposed in parallel; and the metal wires are configured for connecting with a touch integrated circuit.

The second aspect of the present disclosure provides a touch display panel. The touch display panel comprises an lower substrate, an upper substrate that is cell-assembled with the lower substrate, and a touch integrated circuit; the upper substrate comprises a first substrate a first wire grid polarizer disposed on one side of the first substrate, which side faces the lower substrate; the first wire grid polarizer comprises a plurality of metal wires disposed in parallel; and the metal wires are configured to be connected with the touch integrated circuit.

The third aspect of the present disclosure provides a touch display screen. The touch display screen comprises the touch display panel according to anyone of the second aspect of the present disclosure.

The fourth aspect of the present disclosure provides an electronic device. The electronic device comprises the touch display screen according to the third aspect of the present disclosure.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure; and those skilled in the art can obtain other drawings according to these drawings without inventive work.

FIG. 1 is a structure schematic view of a touch display substrate according to an embodiment of the present disclosure;

FIG. 2A is a structure schematic view of another touch display substrate according to an embodiment of the present disclosure;

FIG. 2B is a schematic view showing a connection to metal wires of a wire grid polarizer according to an embodiment of the present disclosure;

FIG. 3 is a structure schematic view of a touch display panel according to an embodiment of the present disclosure;

FIG. 4 is a structure schematic view of another touch display panel according to an embodiment of the present disclosure; and

FIG. 5 is a structure schematic view of another touch display panel according to an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In a touch display screen of an in-cell technology, touch electrodes and sensing electrodes are disposed on the upper substrate and the lower substrate a liquid crystal display panel respectively; thus the display function as well as the touch function can be realized. On one hand, the touch display screen of the in-cell technology is thinner than the touch display screen that is formed by disposing a touch panel on a liquid crystal display panel, however, it still cannot meet the requirement on light weight and thin profile of mobile terminal devices; on the other hand, a common electrode Vcom is divided into sub-electrodes and is controlled in a time-sharing mode to realize both touch function and display function, however, the common electrode Vcom need to be controlled in a time-sharing mode by the touch integrated circuit (IC) and the display IC, and the control coordination is difficult.

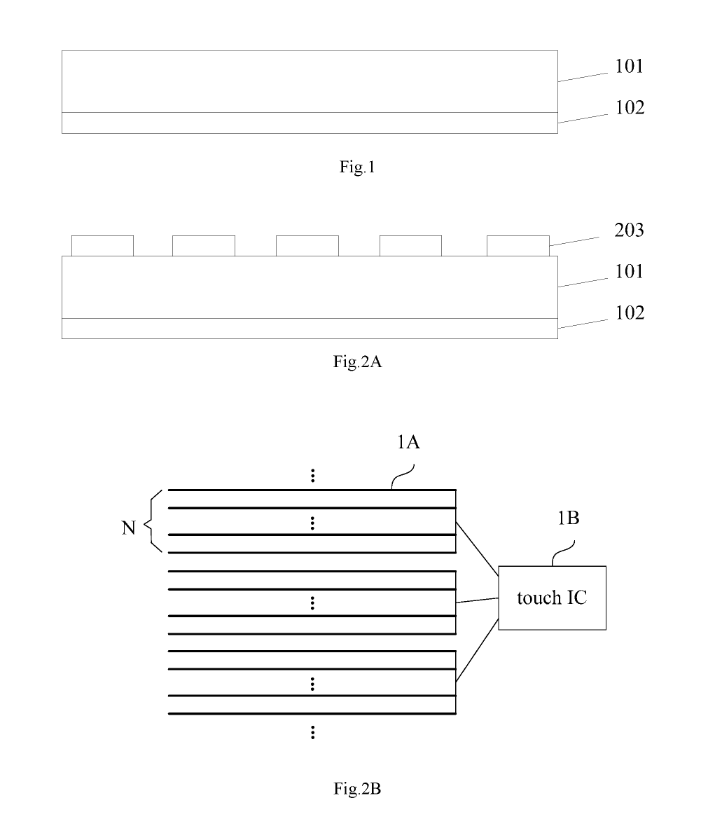

FIG. 1 is a structure schematic view of a touch display substrate according to an embodiment of the present disclosure. Referring to FIG. 1, a touch display substrate comprises a base substrate 101 and a wire grid polarizer (WGP) 102 disposed on one side of the base substrate 101. The WGP 102 comprises a plurality of metal wires disposed in parallel; and the metal wires are used for connecting with a touch integrated circuit (IC).

In an embodiment of the present disclosure, the WGP is disposed on the touch display substrate, and the metal wires of the WGP are connected with the touch IC. On one hand, the metal wires are conductive and the WGP comprises a plurality of metal wires disposed in parallel; therefore, the metal wires of the WGP can be used as electrodes in a touch module upon the metal wires of the WGP being connected with the touch IC. On the other hand, the WGP has a polarizing function, thus in the touch display substrate with the WGP, the WGP replaces a polarizer which is accordingly saved in the touch display substrate. Therefore, the touch display substrate becomes thinner, and thus the touch display screen comprising the touch display substrate is thinner accordingly. Furthermore, the electrode Vcom is not required to be divided to realize touch function and display function in the case where the WGP is further used as electrodes in the touch module; and the difficulty in coordinating the touch IC and the display IC is reduced.

In an embodiment of the present disclosure, the touch display substrate shown in FIG. 1 can be an upper substrate or a lower substrate. As shown in FIG. 2A, if the touch display substrate is the upper substrate (the substrate disposed on a side which faces an user when it is in use), the WGP 102 is disposed on one side of the base substrate 101, which side faces the lower substrate; touch electrodes 203 are disposed on the other side of the base substrate 101; and the touch electrodes 203 are connected with the touch IC. The touch electrodes 203, for instance, comprise a plurality of metal wires disposed in parallel with each other. For example, the touch electrodes 203 are vertically disposed with respect to the metal wires of the WGP 102. Because the metal wires of the touch electrodes 203 is not required to be used as a polarizer, compared with the WGP 102, the metal wires can be formed wider, and the gap between adjacent metal wires can be wider. The touch electrodes 203 are disposed on the other side of the base substrate while the WGP 102 mentioned above is used as sensing electrodes, thus a touch module can be obtained. The touch electrodes 203 being disposed on the upper substrate rather than the lower substrate avoids the problem of lack of touch IC control accuracy caused by the interference of display circuit in the case where the touch electrodes 203 are disposed on the lower substrate. That is, the WGP 102 is disposed on one side of the base substrate 101, and the touch electrodes 203 are disposed on the other side of the base substrate 101.

The WGP 102 is a nano-sized metal grating. In an embodiment, in the direction perpendicular to the base substrate 101, the thickness range of each metal wire of the WGP 102 is from 50 nm to 300 nm. This thickness range not only can ensure the normal operation of the WGP that is used as a polarizer and electrodes, but also can ensure that the display screen is still thin.

In an embodiment, for example, in the direction parallel to the base substrate 101, the width range of each metal wire of the WGP 102 is from 10 nm to 100 nm; and the width range of the gap between two adjacent metal wires is from 40 nm to 150 nm.

For example, the thickness range of the metal wires is from 100 nm to 170 nm; the width range of the metal wires is from 30 nm to 50 nm; and the width range of the gap between two adjacent metal wires is from 60 nm to 100 nm. These values are selected to allow the overall performance to be better in the case where the WGP is used as a polarizer and the electrodes.

Further, for example, at least two adjacent metal wires of the WGP 102 are configured as a metal wire group; and all metal wires in a same metal wire group are connected together and then are connected with the touch IC. For example, as shown in FIG. 2B, N metal wires 1A are configured as a metal wire group, and all metal wires 1A in the metal wire group are connected together and then are connected with the touch IC 1B, and here N is a positive integer greater than 1.

In another embodiment, of course, some metal wires in a same metal group can be connected together and then connected to the touch IC. For example, the metal wires disposed alternately in a same metal wire group are electrically connected together and then the metal wires which are connected together to be used as an electrode are connected with the touch IC. Alternatively, the metal wires in each group are numbered, and the metal wires with specific serial number are connected together and then are connected with the touch IC, the number of the metal wires with specific serial number is not limited, as long as greater than 1. For example, every four metal wires are configured as a metal wire group, and the second metal wire and the fourth metal wire are connected together and then the metal wires connected together to be used as an electrode are connected with the touch IC.

For example, each metal wire group comprises 15,000 to 60,000 metal wires. In this configuration, the width of the electrode which is formed by a plurality of metal wires of the WGP is almost same as the width of a normal electrode (3 mm to 6 mm), and the width of the metal wires is thin. The arrangement of the electrodes formed by the WGP is same as the arrangement of normal electrodes, thus the WGP can be used as a polarizer and electrodes at the same time.

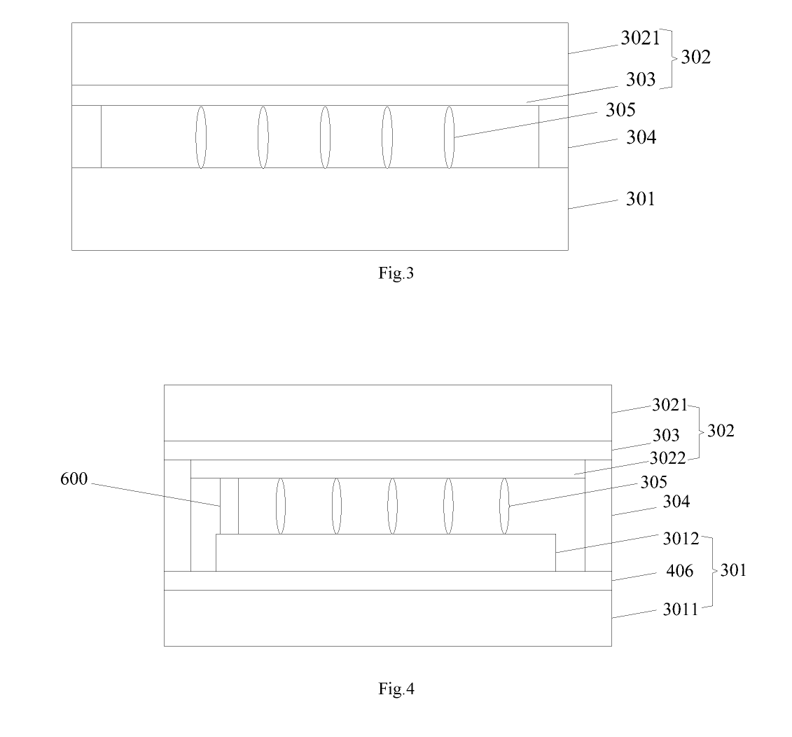

FIG. 3 is a structure schematic view of a touch display panel according to an embodiment of the present disclosure. Referring to FIG. 3, a touch display panel comprises a lower substrate 301 and an upper substrate 302 disposed opposite to the lower substrate 301. The upper substrate 302 comprises a first substrate 3021 and a first WGP 303 disposed on one side of the first substrate 3021, which side faces the lower substrate 301. The first WGP 303 comprises a plurality of metal wires disposed in parallel. The touch display panel further comprises a touch IC (not shown in FIG. 3, referring to FIG. 2B). The metal wires are connected with the touch IC.

The lower substrate 301 and the upper substrate 302 are connected by a sealing structure 304 (for example, sealant) to form a liquid crystal cell. The liquid crystal 305 is disposed between the lower substrate 301 and the upper substrate 302.

In an embodiment of the present disclosure, the WGP is disposed on the touch display substrate, and the metal wires of the WGP are connected with the touch IC. On one hand, the metal wires are conductive and the WGP comprises a plurality of metal wires disposed in parallel; therefore, the metal wires of the WGP can be used as electrodes in a touch module in the case where the metal wires of the WGP are connected with the touch IC. On the other hand, the WGP has a polarizing function, thus in the touch display substrate with the WGP, the WGP replaces a polarizer which is accordingly saved in the touch display substrate. Therefore, the touch display substrate becomes thinner, and thus the touch display screen comprising the touch display substrate is thinner as well. Furthermore, the electrode Vcom is not required to be divided to realize touch function and display function at the same time if the WGP is used as electrodes in the touch module; and the difficulty of coordinating the touch IC and the display IC is reduced.

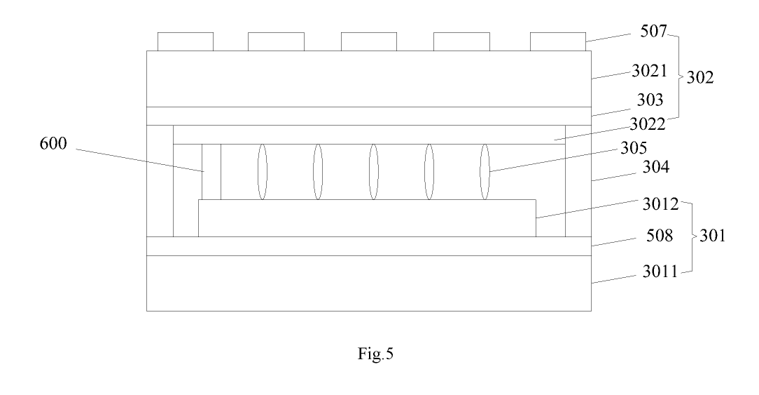

FIG. 4 is a structure schematic view of another touch display panel according to an embodiment of the present disclosure. Referring to FIG. 4, compared with the touch display panel shown in FIG. 3, in the touch display panel shown in FIG. 4, the lower substrate 301 comprises a second substrate 3011 and a second WGP 406 disposed on one side of the second substrate 3011, which side faces the upper substrate 302. The second WGP 406 comprises a plurality of metal wires disposed in parallel, and the metal wires are connected with the touch IC. The metal wires of the first WGP 303 are vertically disposed with respect to the metal wires of the second WGP 406. In the touch display panel shown in FIG. 4, the other electrodes in the touch module are realized by the second WGP 406 of the lower substrate 301. In this configuration, the first WGP 303 is used as the touch electrodes, and correspondingly the second WGP 406 is used as the sensing electrodes. Meanwhile, the second WGP 406 is the polarizer of the lower substrate. This configuration further reduces the thickness of the touch display screen. The configuration of the second WGP 406, for instance, can be implemented with reference to the structure illustrated in FIG. 2A and FIG. 2B.

FIG. 5 is a structure schematic view of another touch display panel according to an embodiment of the present disclosure. Referring to FIG. 5, compared with the touch display panel shown in FIG. 3, in the touch display panel shown in FIG. 5, the upper substrate 302 further comprises touch electrodes 507 disposed on one side of the first substrate 3021, which side is away from the lower substrate 301. The touch electrodes 507 are connected with the touch IC; and the touch electrodes 507 extends vertically with respect to the metal wires of the first WGP 303. The touch electrodes 507 are disposed on one side of the first substrate 3021, which side is away from the lower substrate 301, and the first WGP 303 mentioned above is used as sensing electrodes, thus the touch module is formed. The touch electrodes 507 being disposed on the upper substrate 302 rather than the lower substrate 301 avoids the problem of lack of touch IC control accuracy caused by the interference of display circuit when the touch electrodes 507 are disposed on the lower substrate 301.

For example, touch electrodes 507 are made from a metal or indium tin oxide (ITO), and the thickness range of the metal wires is from 50 nm to 300 nm.

Further, the lower substrate 301 comprises a second substrate 3011 and a polarizer 508 disposed on one side of the second substrate 3011, which side faces the upper substrate 302.

In one embodiment, the polarizer 508 can be a WGP; and the polarizer 508 and the first WGP 303 that is the polarizer of the upper substrate 302 are made from a same kind of material. This configuration is easy to be realized.

In other embodiments, the polarizer 508 can be a polarizer provided in other conventional structure such as a polarizer in a structure comprising a polyving akohol film interposed between two cellulose triacetate films.

In the touch display panel according to anyone of FIG. 3 to FIG. 5, in the direction perpendicular to the first substrate 3021, the thickness range of each metal wire of the WGP 303 is from 50 nm to 300 nm. The thickness range not only can ensure the normal operation of the first WGP 303 that is used as a polarizer and the electrodes, but also can ensure that the display screen is thin.

For example, in one embodiment, in the direction parallel to the first substrate 3021, the width range of each metal wire of the first WGP 303 is from 10 nm to 100 nm; and the width range of the gap between two adjacent metal wires is from 40 nm to 150 nm.

For example, the thickness range of the metal wires is from 100 nm to 170 nm; the width range of the metal wires is from 30 nm to 50 nm; and the width range of the gap between two adjacent metal wires is from 60 nm to 100 nm.

Further, at least two adjacent metal wires of the WGP 303 are configured as a metal wire group; and all metal wires in a same metal wire group are connected together and then are connected with the touch IC. For example, as shown in FIG. 2B, N metal wires 1A are configured as a metal wire group, and all metal wires 1A in the metal wire group are connected together and then are connected with the touch IC 1B, where N is a positive integer greater than 1.

In another embodiment, of course, some metal wires in a same metal group can be connected together and then connected to the touch IC. For example, the metal wires disposed alternately in a same metal wire group are electrically connected together and then the metal wires which are connected together to be used as an electrode are connected with the touch IC. Alternatively, the metal wires in each group are numbered, and the metal wires with specific serial number are connected together and are connected with the touch IC; the number of the metal wires with specific serial number is not limited, as long as greater than 1.

For example, each metal wire group comprises 15,000 to 60,000 metal wires. In this configuration, the width of the electrode which is formed by a plurality of metal wires of the WGP is almost same as the width of a normal electrode (3 mm to 6 mm), and the width of the metal wires is thin. The arrangement of the electrodes formed by the WGP is same as the arrangement of normal electrodes, thus the WGP can be used as a polarizer and electrodes at the same time.

In the touch display panel according to anyone of FIG. 3 to FIG. 5, the lower substrate 301 can be an array substrate. As shown in FIG. 4 or FIG. 5, the array substrate further comprises an array driving structure disposed on the second substrate 3011. The array driving structure may comprise thin film transistors 3012, gate lines, data lines, and etc. The gate lines and the data lines are intercrossed to define sub-pixels; and each sub-pixel, for instance, comprises a thin film transistor serving as a switching element. The second WGP 406 or the polarizer 508 can be disposed between the second substrate 3011 and the thin film transistor 3012. Certainly, the second WGP 406 or the polarizer 508 can also be disposed on one side of the thin film transistor 3012, which side is away from the second substrate 3011.

In the touch display panel according to anyone of FIG. 3 to FIG. 5, the upper substrate 302 can be a color filter substrate. As shown in FIG. 4 or FIG. 5, the color filter substrate further comprises a color film 3022 disposed on the first substrate 3021; and the first WGP 303 can be disposed between the first substrate 3021 and the color film 3022. Of course, the first WGP 303 also can be disposed on one side of the color film 3022, which side is away from the first substrate 3021. The color film 3022, for instance, comprises a plurality of color filter units corresponding to the sub-pixels on the array substrate, such as red filter units, green filter units and blue filter units.

Referring to FIG. 4 or FIG. 5, the touch display panel can further comprise spacers 600 disposed between the upper substrate 302 and the lower substrate 301.

For example, the spacers 600 are dot spacers or photo spacers. The two configurations can realize the separation between the touch electrodes and the sensing electrodes. The spacers 600 can be formed form an acryl resin, a glass material or other material.

An embodiment of the present disclosure further provides a touch display screen comprising the touch display panel according to anyone of FIG. 3 to FIG. 5.

In an embodiment of the present disclosure, the WGP is disposed on the touch display substrate, and the metal wires of the WGP are connected with the touch IC. On one hand, the metal wires are conductive and the WGP comprises a plurality of metal wires disposed in parallel; therefore, the metal wires of the WGP can be used as electrodes in a touch module in the case where the metal wires of the WGP are connected with the touch IC. On the other hand, the WGP has a polarizing function, thus in the touch display substrate with the WGP, the WGP replaces the polarizer which is accordingly saved in the touch display substrate. Therefore, the touch display substrate is thinner, and thus the touch display screen comprising the touch display substrate is thinner as well. Furthermore, the electrode Vcom is not required to be divided to realize touch function and display function in the case where the WGP is used as electrodes in the touch module; and the difficulty in coordinating the touch IC and the display IC is reduced.

An embodiment of the present disclosure further provides an electronic device comprising the touch display screen aforementioned. The display device can be any product or component having a display function such as mobile phone, tablet computer, television, display screen, laptop computer, digital photo frame, navigator or the like.

What are described above is related to the illustrative embodiments of the disclosure only and not limitative to the scope of the disclosure. Any modification, equivalent replacement, or improvement, within the spirit and the principle of the disclosure, should be within the scope of the disclosure.

The present application claims the priority of the Chinese Patent Application No. 201610059843.8 filed on Jan. 28, 2016, which is incorporated herein in its entirety by reference as part of the disclosure of the present application.

What is claimed is:

1. A touch display substrate, comprising a base substrate and a wire grid polarizer disposed on one side of the base substrate,
wherein the wire grid polarizer comprises a plurality of metal wires disposed in parallel; and the metal wires are configured for connecting with a touch integrated circuit.

2. The touch display substrate according to claim 1, wherein touch electrodes are disposed on other side of the base substrate; the touch electrodes are configured to be connected with the touch integrated circuit; and the touch electrodes are vertically disposed with respect to the metal wires of the wire grid polarizer.

3. The touch display substrate according to claim 1, wherein in a direction perpendicular to the base substrate, a thickness range of each metal wire of the wire grid polarizer is from 50 nm to 300 nm.

4. The touch display substrate according to claim 1, wherein in a direction parallel to the base substrate, a width range of each metal wire of the wire grid polarizer is from 10 nm to 100 nm; and
a width range of a gap between two adjacent metal wires is from 40 nm to 150 nm.

5. The touch display substrate according to claim 4, wherein at least two adjacent metal wires of the wire grid polarizer are configured as a metal wire group; and
all metal wires in a same metal wire group are connected together and are configured to be connected with the touch integrated circuit.

6. The touch display substrate according to claim 5, wherein a metal wire group comprises 15,000 to 60,000 metal wires.

7. A touch display panel, comprising a lower substrate, an upper substrate that is cell-assembled with the lower substrate, and a touch integrated circuit,
wherein the upper substrate comprises a first substrate and a first wire grid polarizer disposed on one side of the first substrate, which side faces the lower substrate;
the first wire grid polarizer comprises a plurality of metal wires disposed in parallel; and
the metal wires are configured to be connected with the touch integrated circuit.

8. The touch display panel according to claim 7, wherein the lower substrate comprises a second substrate and a second wire grid polarizer disposed on one side of the second substrate, which side faces the upper substrate;
the second wire grid polarizer comprises a plurality of metal wires disposed in parallel;
the metal wires are configured to be connected with the touch integrated circuit; and
the metal wires of the first wire grid polarizer are vertically disposed with respect to the metal wires of the second wire grid polarizer.

9. The touch display panel according to claim 7, wherein the upper substrate further comprises touch electrodes disposed on one side of the first substrate, which side is away from the lower substrate;
the touch electrodes are configured to be connected with the touch integrated circuit; and
the touch electrodes are vertically disposed with respect to the metal wires of the first wire grid polarizer.

10. The touch display panel according to claim 9, wherein the lower substrate comprises a second substrate and a polarizer disposed on one side of the second substrate, which side faces the upper substrate.

11. The touch display panel according to claim 10, wherein the polarizer is a wire grid polarizer.

12. The touch display panel according to claim 7, wherein in a direction perpendicular to the first substrate, a thickness range of each metal wire of the first wire grid polarizer is from 50 nm to 300 nm.

13. The touch display panel according to claim 7, wherein in a direction parallel to the first substrate, a width range of each metal wire of the first wire grid polarizer is from 10 nm to 100 nm; and
a width range of a gap between two adjacent metal wires is from 40 nm to 150 nm.

14. The touch display panel according to claim 13, wherein at least two adjacent metal wires of the first wire grid polarizer are configured as a metal wire group; and
all metal wires in a same metal wire group are connected together and are configured to be connected with the touch integrated circuit.

15. The touch display panel according to claim 14, wherein a metal wire group comprises 15,000 to 60,000 metal wires.

16. The touch display panel according to claim 7, wherein the lower substrate is an array substrate.

17. The touch display panel according to claim 7, wherein the upper substrate is a color filter substrate.

18. The touch display panel according to claim 7, further comprising spacers disposed between the upper substrate and the lower substrate.

19. A touch display screen, comprising the touch display panel according to claim 7.

20. An electronic device, comprising the touch display screen according to claim 19.
